(19) United States
(12) Patent Application Publication
(10) Pub. No.: US 2022/0179764 A1
(43) Pub. Date: Jun. 9, 2022

(54) MULTI-SOURCE DATA CORRELATION EXTRACTION FOR ANOMALY DETECTION

(71) Applicant: International Business Machines Corporation, Armonk, NY (US)

(72) Inventors: Yuk L. Chan, Rochester, NY (US); Tian Wu, Beijing (CN); Lei Yu, Sleepy Hollow, NY (US); Jia Qi Li, Beijing (CN); Zhi Shuai Han, Beijing (CN); Hong Min, Hopewell Junction, NY (US); Fan Jing Meng, Beijing (CN); Abhishek Dokania, Hilliard, OH (US)

(21) Appl. No.: 17/110,432

(22) Filed: Dec. 3, 2020

(51) Int. Cl. G06F 11/30; G06F 11/07; G06F 40/30

(52) U.S. Cl. CPC G06F 11/3006; G06F 40/30; G06F 11/0787; G06F 11/3075

(57) ABSTRACT

According to an aspect a computer-implemented method includes identifying a plurality of metrics and log identifiers that describe similar information as a plurality of documentation-based correlation data. One or more metric pair correlations are identified. One or more log frequency correlations are identified by temporal correlation. A plurality of correlated metric-log pairs is identified. A correlation database is populated with the documentation-based correlation data, the one or more metric pair correlations, the one or more log frequency correlations, and the correlated metric-log pairs to support anomaly detection in one or more monitored computer systems.

### BACKGROUND

The present invention generally relates to computer systems, and more specifically, to computer systems, computer-implemented methods, and computer program products for multi-source data correlation extraction for anomaly detection and problem diagnosis.

In computing, different types of logs can be generated during system operation to record various events. The logs typically contain text data and may also include numeric data. Computer systems may also have various performance monitors that track resource utilization, such as memory, disk, processor, thread count, and other such metrics. Metric data may be packed into records, where record fields can be of various data types, sizes, and offset locations. Where metric data is packed or encoded as binary values, it may not be readily interpreted directly by computer system users. Log data and metric data can be generated at different time scales and separately managed through different system monitoring and reporting tools.

### SUMMARY

Embodiments of the present invention are directed to multi-source data correlation extraction for anomaly detection. A non-limiting example computer-implemented method includes identifying a plurality of metrics and log identifiers that describe similar information as a plurality of documentation-based correlation data. One or more metric pair correlations are identified. One or more log frequency correlations are identified by temporal correlation. A plurality of correlated metric-log pairs is identified. A correlation database is populated with the documentation-based correlation data, the one or more metric pair correlations, the one or more log frequency correlations, and the correlated metric-log pairs to support anomaly detection in one or more monitored computer systems.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 is a block diagram of a system for multi-source data correlation extraction in accordance with one or more embodiments of the present invention;

FIG. 3 is a block diagram of a dataflow for multi-source data correlation extraction in accordance with one or more embodiments of the present invention;

FIG. 4 depicts an example of documentation of metrics in accordance with one or more embodiments of the present invention;

FIG. 5 depicts an example of a log in accordance with one or more embodiments of the present invention;

FIG. 6 depicts an example of documentation of a log in accordance with one or more embodiments of the present invention;

FIG. 7 depicts an example of correlating documentation of a metric to a log template in accordance with one or more embodiments of the present invention;

FIG. 8 is a flowchart of multi-source data correlation extraction in accordance with one or more embodiments of the present invention;

FIG. 9 depicts a cloud computing environment according to one or more embodiments of the present invention; and

FIG. 10 depicts abstraction model layers according to one or more embodiments of the present invention.

### DETAILED DESCRIPTION

One or more embodiments of the present invention are configured to discover relationships between metrics and log data collected during operation of one or more monitored computer systems. Relationships between multiple metrics can be discovered based on a computer-implemented analysis of documentation that describes a plurality of metrics and explanations of the metrics. Relationships between log data can be discovered based on analysis of log formats and explanations of log data. Coexistence analysis can be used to search for linking data appearing in multiple locations within documentation to establish relationships between metrics and log message identifiers, for example. User input, as expert knowledge, may be used to specify known correlated metrics and/or log data. Semantic analysis can be used to analyze the context of explanations in documentation, for instance, using natural language processing to determine semantic similarity and identify correlated metrics and/or log data. Documentation can include user documents and manuals stored in an electronic format, as well as template files, and/or other material from which relationship data can be extracted. Results of the analysis can be stored in a correlation database for subsequent use during anomaly detection and/or problem diagnosis associated with the monitored computer systems or other such computer systems.

One or more embodiments can also determine correlations through analysis of collected data from one or more monitored computer systems. For example, metric data can be collected as time-based series of values when monitoring various performance parameters using counters, timeout tracking, and other such metrics. A pairwise analysis of combinations of metric series can determine a relative correlation between each series pair. Metric series pairs with a metric correlation coefficient greater than a metric coefficient threshold can be considered highly correlated, with the relationship tracked in the correlation database. Similarly, log data from one or more logs can be compared, for instance, using a frequency-based analysis. A log frequency can be determined based on counting a number of occurrences of a log identifier in a window of time and generating frequency series of the log identifier over multiple windows of time. Log frequency series data can be compared pairwise for multiple data sets to determine a log correlation coefficient for frequency data patterns. One or more log frequency correlations can be identified based on comparing the log correlation coefficient between pairs of log frequency series to a log frequency correlation threshold, with the relationship tracked in the correlation database. Further correlation modeling can be performed by normalizing metric series relative to log frequency series data to determine correlated pairings of metrics and log identifiers, with the relationship tracked in the correlation database. Other correlation relationships may also be tracked, for example, with respect to direct and indirect correlation relationships.

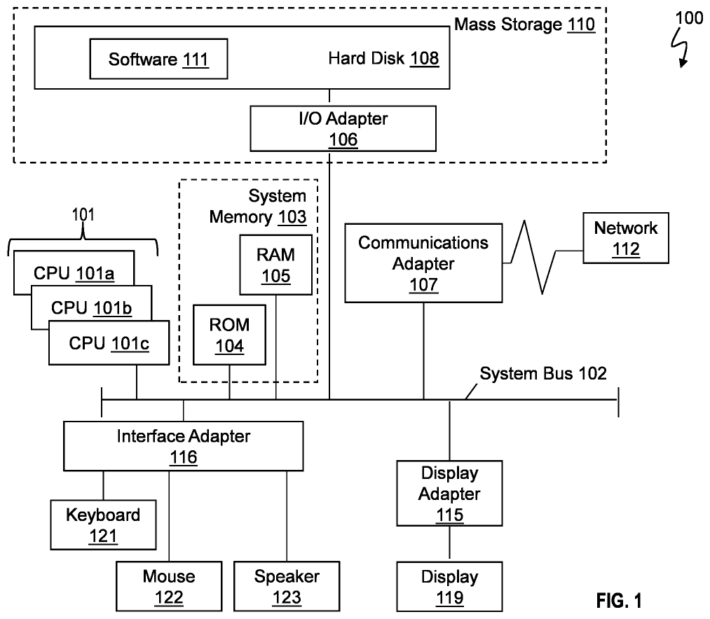

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, etc., can be interconnected to the system bus 102 via the interface adapter 116, which may include, for example, a Super I/o chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, and, storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

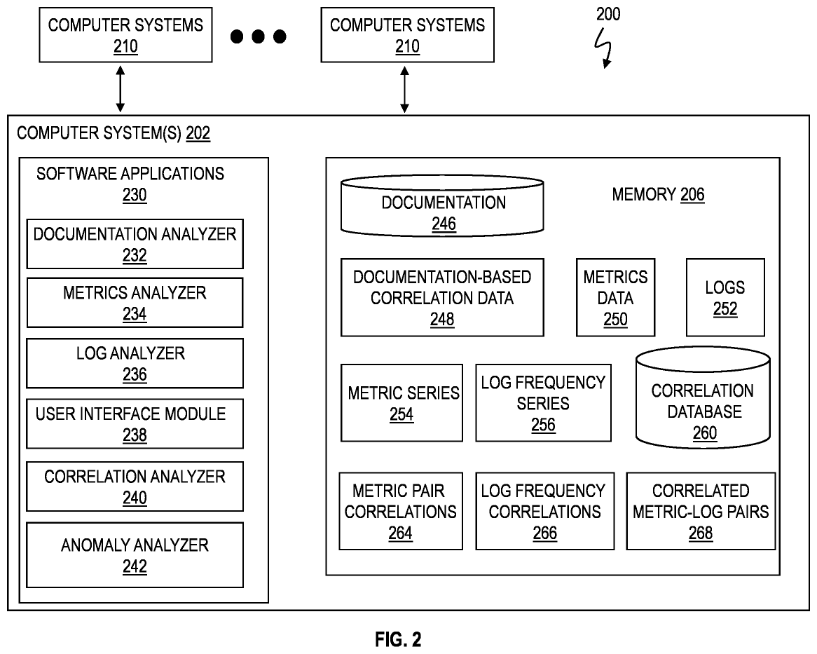

FIG. 2 is a block diagram of a system 200 for multi-source data correlation extraction in accordance with one or more embodiments of the present invention. FIG. 2 depicts one or more computers systems 202 coupled to one or more computer systems 210 via a wired and/or wireless network. For example, computer system 202 can be representative of numerous computers in a datacenter servicing various users, and computer systems 210 can be representative of numerous computers in a datacenter. One or more of the computer systems 202 can be configured to collect metrics and logs associated with the operation of one or more of the computer systems 210, where the computer systems 210 can also be referred to as monitored computer systems 210. The monitored computer systems 210 may be observed to collect representative performance data and events during operation of the system 200. Elements of the computer system 100 of FIG. 1 may be used in and/or integrated into computer systems 202 and computer systems 210. One or more software applications 230 can include a documentation analyzer 232, a metrics analyzer 234, a log analyzer 236, a user interface module 238, a correlation analyzer 240, and an anomaly analyzer 242. The software applications 230 may utilize and/or be implemented as software 111 executed on one or more processors 101, as discussed in FIG. 1.

The documentation analyzer 232 is configured to analyze documentation 246, which may be stored in memory 206 of one or more computer systems 202 or be accessible from one or more other locations, for instance, through a network connection. The documentation 246 can include user manuals, maintenance manuals, service bulletins, templates, and/or any other source explaining how to interpret metrics data 250 and logs 252 associated with the operation of one or more monitored computer systems 210. Metrics analyzer 234 can parse metrics data 250 and generate metric series 254 that summarize sequences of metrics captured over a period of time. Log analyzer 236 can parse logs 252 and summarize log data as log frequency series 256. The user interface module 238 can accept user input to identify known relationships between metrics and log identifiers, for example, to support knowledge-based correlation analysis. The correlation analyzer 240 can identify various correlations within data sets and between datasets that imply relationships. For example, the documentation analyzer 232 may find information related to a plurality of metrics and log identifiers within the documentation 246, and the correlation analyzer 240 can find similar information related to the metrics and log identifiers, capturing the results in documentation-based correlation data 248. The correlation analyzer 240 may also analyze metric series 254 to identify metric pair correlations 264, analyze log frequency series 256 to determine log frequency correlations 266, and analyze combinations of the metric series 254 with the log frequency series 256 to determine correlated metric-log pairs 268.

Results of correlation extraction, such as the documentation-based correlation data 248, metric pair correlations 264, log frequency correlations 266, and/or correlated metric-log pairs 268 can be captured and stored in a correlation database 260. The correlation database 260 can be formatted to support rapid look-up operations, such that when an anomaly is subsequently detected during operation of the monitored computer systems 210, the anomaly analyzer 242 can access the correlation database 260 to assist in determining whether a suspected anomaly is likely an actual problem or more likely a false positive. For instance, where a metric is associated with an anomaly, upon detection of the metric, the anomaly analyzer 242 may access the correlation database 260 to determine other related metrics and/or log data that should likely occur in combination with the metric and then verify whether related metrics and/or log data are have also been detected. A combination of two or more metrics and log identifiers occurring in an expected pattern can provide a stronger indicator as to whether a detected anomaly is an actual anomaly or a false positive. In some embodiments, the anomaly analyzer 242 can be implemented on a separate instance of the computer system 202 than the computer system 202 used to populate the correlation database 260.

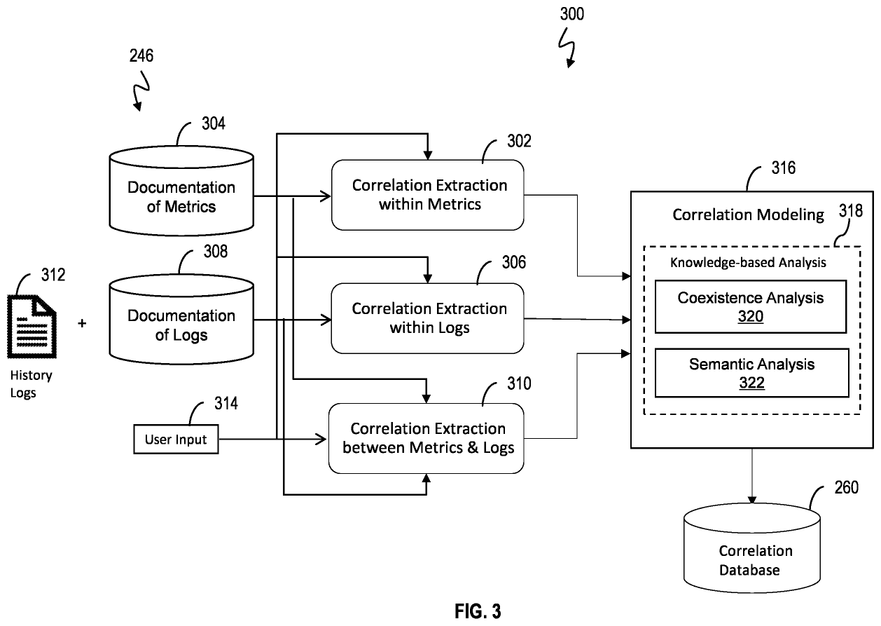

FIG. 3 is a block diagram of a dataflow 300 for multi-source data correlation extraction in accordance with one or more embodiments. The correlation analyzer 240 of FIG. 2 can include multiple modules, such as module 302 that performs correlation extraction within metrics based on documentation of metrics 304 and user input 314. A module 306 can perform correlation extraction within logs based on documentation of logs 308, user input 314, and various logs, such as history logs 312. A module 310 can perform correlation extraction between metrics and logs based on documentation of metrics 304, documentation of logs 308, history logs 312, and user input 314. The documentation of metrics 304 can be a subset of the documentation 246 of FIG. 2 that defines metric names, metric explanations, and/or formatting related to possible metrics that may be observed in the metrics data 250 of FIG. 2. The documentation of logs 308 can be a subset of the documentation 246 of FIG. 2 that defines log identifiers, log explanations, and/or formatting related to possible log data that may be observed in the logs 252 of FIG. 2, where the history logs 312 may be a subset of the logs 252. User input 314 can be received through the user interface module 238 of FIG. 2 as expert knowledge used to provide known correlations between metrics and/or log data that can extend beyond relationships which may be extracted from the documentation of metrics 304 and/or the documentation of logs 308.

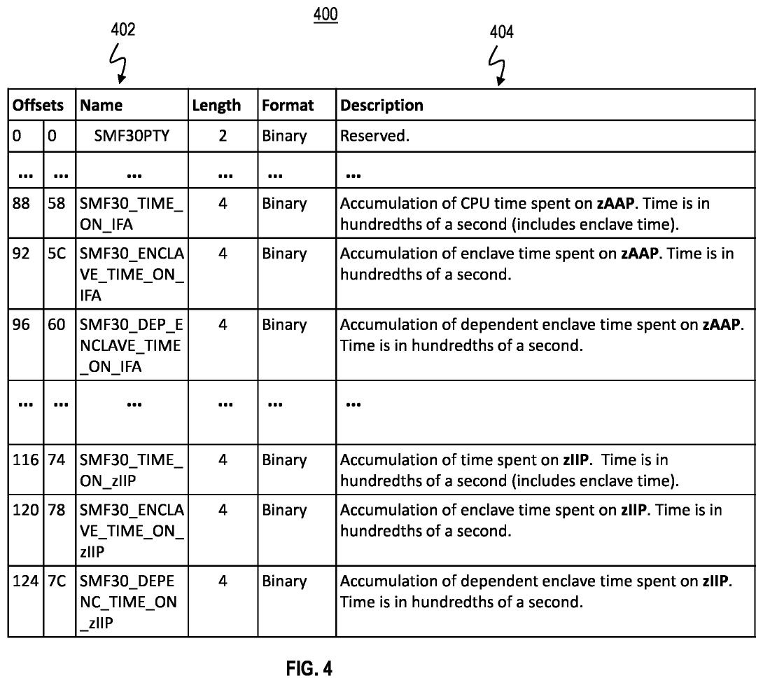

Correlation modeling 316 can use a combination of coexistence analysis 320 and semantic analysis 322, which can be further refined through knowledge-based analysis 318 to populate the correlation database 260. With respect to metrics, the coexistence analysis 320 can include identifying a metric and/or an explanation of the metric to look for references to another metric or log data. Knowledge-based analysis 318 can augment the coexistence analysis 320 by identifying metrics that are considered key metrics associated with known anomaly conditions and any known metric correlations to the key metrics. The semantic analysis 322 can analyze the context of a metric explanation using, for instance, natural language processing techniques and calculate semantic similarity to identify correlated metric pairs, which can be tracked in the metric pair correlations 264 of FIG. 2. As one example, the documentation of metrics 304 can include a metric record definition 400 of FIG. 4 that defines a plurality of metric names 402 as well as other related information, such as metric explanations 404. The metric names 402 can serve as a list to search the metric explanations 404 for direct references to other metrics. The semantic analysis 322 can parse the metric explanations 404 to look for similar terms and context information that may be used in other locations in the documentation of metrics 304 and/or the documentation of logs 308.

In an embodiment, the coexistence analysis 320 can use the semantic analysis 322 by applying natural language processing techniques to the metric explanations 404, and identify terms such as nouns, subjects, objects, verbs etc. A dictionary database (not depicted) can be used to identify the importance of the terms and assign a weight to the nouns for co-existing matching. The weight will be higher if the noun is more important for coexisting analysis, and the weight will be lower if the noun is less important for coexisting analysis. The dictionary database can be provided by or generated for a particular product associated with the documentation 246. For example, zAAP, zIIP are well-known nouns representing different types of processors, and as such, can be used to link groups of metrics together as depicted in FIG. 4. The dictionary database can also be manually defined by a user. Furthermore, the dictionary database can be learned or updated by applying natural language processing techniques to the metric explanations 404. For example, nouns that appear in 5-20% of the metric explanations 404 can be identified as more important terms. A noun that appears with a frequency that is too low or appears too often may not be useful in correlating metrics. In the example of FIG. 4, metrics of SMF30_TIME_ON_IFA, SMF30_ENCLAVE_TIME_ON_IFA, and SMF30_DEP_ENCLAVE_TIME_ON_IFA can be identified as related through a common noun of zAAP, and metrics of SMF30_TIME-ON_zIIP, SMF30_ENCLAVE_TIME_ON_zIIP, and SMF30_DEPENC_TIME_ON_zIIP can be identified as related based on a common noun of zIIP.

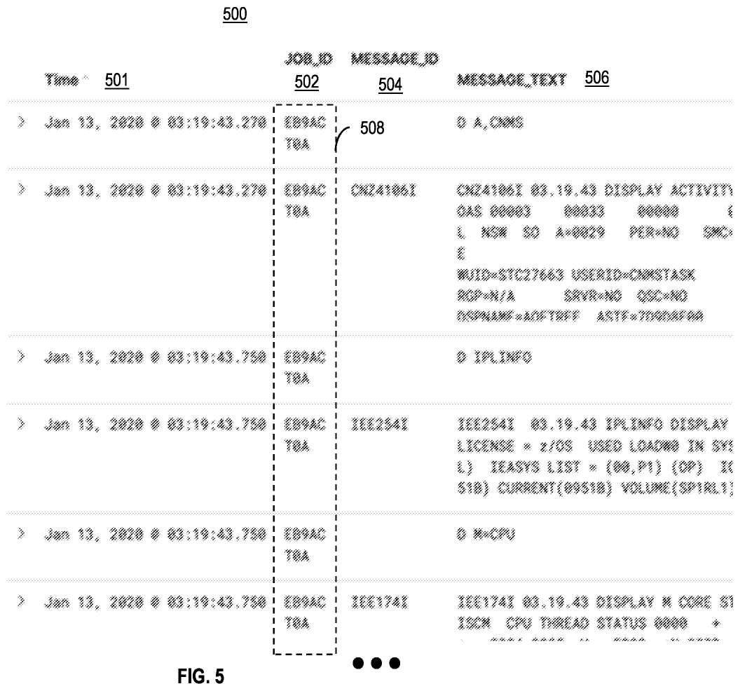

As another example, the history logs 312 of FIG. 3 can be analyzed to look for sequences. A history log sequence 500 of FIG. 5 can include a time-based sequence of log entries associated with one or more job identifiers 502. Message identifiers 504, which can also be referred to as log identifiers 504, can indicate a log event with associated message text 506. Time data 501 can be used to determine how frequently log sequences occur. As illustrated in the example of FIG. 5, a group 508 of job identifiers 502 can be identified by the coexistence analysis 320 of FIG. 3 as having a log sequence of message identifiers 504, for instance, CNZ4106I, followed by IEE254I and IEE174I. The knowledge-based analysis 318 of FIG. 3 can augment the coexistence analysis 320 by identifying known correlated log identifiers which may exist in the log identifiers 504.

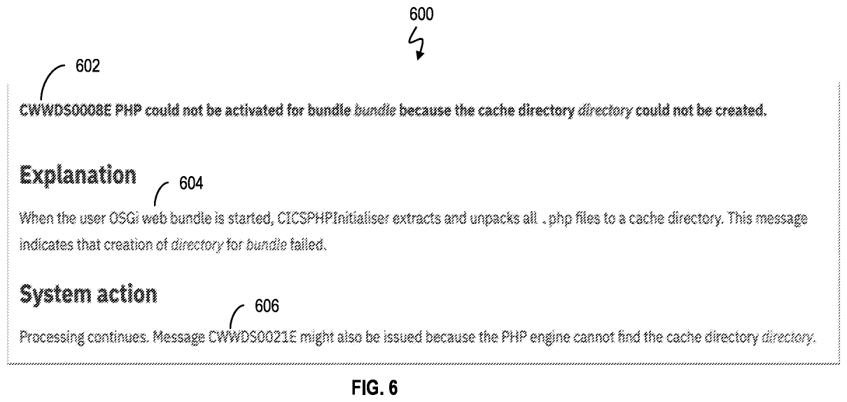

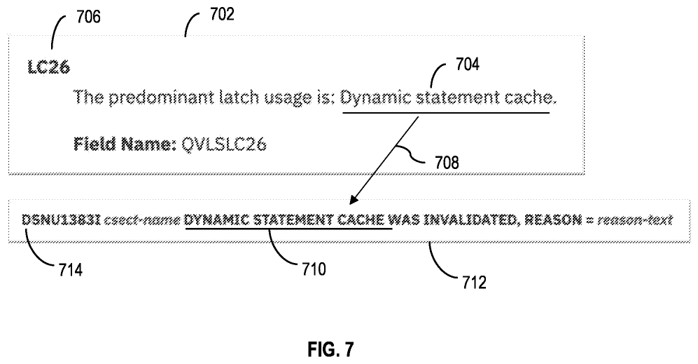

The semantic analysis 322 of FIG. 3 can analyze the context of log identifier descriptions, for example, by accessing the documentation of logs 308 and using natural language processing techniques. Log documentation 600 of FIG. 6 is an example of extracted description information from the documentation of logs 308 of FIG. 3. A log identifier 602, such as CWWDS008E, can be in a description with an associated explanation 604, with further contextual information extracted from a system action description 606, which may provide further context in establishing similarity and correlations with other log identifiers and/or metrics. As another example, FIG. 7 illustrates how metric documentation 702 from the documentation of metrics 304 of FIG. 3 may include a metric explanation 704 associated with a metric 706 that can be identified by the coexistence analysis 320 of FIG. 3 as correlated 708 to a shared term 710 of a log template 712 for a log identifier 714, thereby correlating the metric 706 with the log identifier 714. The semantic analysis 322 of FIG. 3 can also be used to analyze metric explanations and log explanations using natural language processing to determine semantic similarity and identify correlated metric-log pairs, which can be stored in the correlated metric-log pairs 268 of FIG. 2.

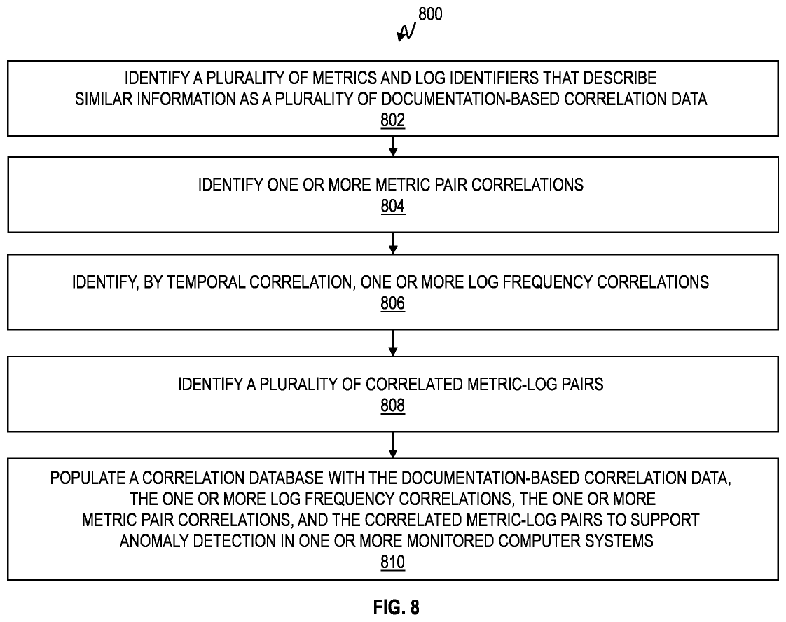

FIG. 8 is a flowchart 800 of multi-source data correlation extraction according to one or more embodiments of the invention. The flowchart 800 is described in reference to FIGS. 1-8 and may include additional steps not depicted in FIG. 8. Although depicted in a particular order, the blocks depicted in FIG. 8 can be rearranged, subdivided, and/or combined.

At block 802, the system 200 can identify a plurality of metrics and log identifiers that describe similar information as a plurality of documentation-based correlation data 248. Identifying can be performed by analyzing documentation 246. Analyzing the documentation 246 can include performing coexistence analysis 320 to identify each of the metrics and related explanation documentation, such as metric names 402 and metric explanations 404. One or more metric correlations can be defined based on user input 314. Similar information can be identified based on semantic analysis 322 of the related explanation documentation using natural language processing. Analyzing the documentation 246 can also or alternatively include performing coexistence analysis 320 to identify one or more log identifiers from one or more history logs 312 and related explanation documentation, such as log identifiers 504. Similar information can be identified based on semantic analysis 322 of the related explanation documentation using natural language processing to identify one or more correlated log identifier pairs. One or more log identifier correlations can be defined based on user input 314. The user input 314 can include annotations by an expert to support knowledge-based analysis 318, which may be more robust than using unsupervised training with machine learning techniques.

At block 804, the system 200 can identify one or more metric pair correlations 264. The one or more metric pair correlations 264 can be identified by analyzing a plurality of metric pair combinations from metrics data 250 associated with one or more monitored computer systems 210. Analyzing the metric pair combinations can include determining a correlation coefficient between pairs of the metric series 254 and identifying the one or more metric pair correlations 264 based on comparing the correlation coefficient between pairs of the metric series 254 to a metric correlation threshold. For example, one of the metric series 254 extracted from the metrics data 250 may be associated with a sequence of latch counter readings, while another one of the metric series 254 extracted from the metrics data 250 may be associated with a sequence of timeout readings. Each of the metric series 254 can be decomposed into subsequences for a shared window of time and normalized. Normalizing can include rescaling, for instance, the metric series 254 in magnitude and/or time through interpolation, extrapolation, or other such techniques. A correlation coefficient can be calculated by pattern matching, frequency-based analysis, or other techniques that indicate a relative level of similarity between the metric series 254. As one example, similarities can be scaled between value of zero and one, where values closer to one indicate a higher similarity. Correlated pairs and correlation scores can be recorded in the metric pair correlations 264 for correlations exceeding the metric correlation threshold, for instance, greater than 0.5 correlation.

At block 806, the system 200 can identify, by temporal correlation, one or more log frequency correlations 266. Temporal correlation can be applied to one or more logs 252 of the one or more monitored computer systems 210. Applying temporal correlation to one or more logs 252 further can include determining a correlation coefficient between pairs of the log frequency series 256 and identifying the one or more log frequency correlations 266 based on comparing the correlation coefficient between pairs of the log frequency series 256 to a log frequency correlation threshold. For example, a time-window size of ten minutes, or another such value, can be used as a basis to analyze a sequence of ten-minute increments of the logs 252 to count the occurrence of a same log identifier per time window. Therefore, log frequency series 256 for a log identifier of DSNU1383I having values of 45, 23, 21, and 4 would indicate that the log identifier of DSNU1383I was found 45 times in the first ten-minute window, 23 times in the second ten-minute window, 21 times in the third ten-minute window, and 4 times in the fourth ten-minute window. Each of the log frequency series 256 can be normalized for comparison. Normalizing can include rescaling, for instance, the log frequency series 256 in magnitude and/or time through interpolation, extrapolation, or other such techniques. A correlation coefficient can be calculated by pattern matching, frequency-based analysis, or other techniques that indicate a relative level of similarity between the log frequency series 256. As one example, similarities can be scaled between value of zero and one, where values closer to one indicate a higher similarity. Correlated pairs and correlation scores can be recorded in the log frequency correlations 266 for correlations exceeding the metric correlation threshold, for instance, greater than 0.5 correlation.

At block 808, the system 200 can identify a plurality of correlated metric-log pairs 268. The correlated metric-log pairs 268 can be identified by analyzing a plurality of metric series 254 temporally aligned with a plurality of log frequency series 256. Analyzing the metric series 254 temporally aligned with the log frequency series 256 can include determining a correlation coefficient between pairs of metric series 254 and the log frequency series 256 and identifying the correlated metric-log pairs 268 based on comparing the correlation coefficient between pairs of metric series 254 and the log frequency series 256 to a metric-log pair correlation threshold. Normalizing can include rescaling, for instance, the metric series 254 and the log frequency series 256 in magnitude and/or time through interpolation, extrapolation, or other such techniques. A correlation coefficient can be calculated by pattern matching, frequency-based analysis, or other techniques that indicate a relative level of similarity between the metric series 254 and the log frequency series 256. As one example, similarities can be scaled between value of zero and one, where values closer to one indicate a higher similarity. Correlated pairs and correlation scores can be recorded in the correlated metric-log pairs 268 for correlations exceeding the metric correlation threshold, for instance, greater than 0.5 correlation. Further, indirect correlations may also be tracked. For example, if a log identifier “DSNU1383I” is correlated with a metric “LATCH_COUNTER_26”, and metric “LATCH_COUNTER_26” is correlated with metric “LATCH_COUNTER_24” according to the metrics correlation, then the log identifier “DSNU1383I” and metric “LATCH_COUNTER_24” can be marked as “indirectly correlated”.

At block 810, the system 200 can populate the correlation database 260 with the documentation-based correlation data 248, the one or more metric pair correlations 264, the one or more log frequency correlations 266, and the correlated metric-log pairs 268 to support anomaly detection in the one or more monitored computer systems 210. The anomaly analyzer 242 can perform anomaly detection and diagnosis, for example, as new values are added to the metrics data 250 and logs 252 for one or more of the monitored computer systems 210. An anomaly may correspond to and identify a problem in hardware components (e.g., processors, memory, caches, registers, I/O connectors, etc.) and/or software components (e.g., software applications, operating systems, protocols, backup software applications, etc.). The correlation database 260 can be used to determine a likelihood that a detected anomaly is an actual anomaly, where correlated metrics and/or log data are observed in an expected combination or sequence.

Technical advantages and benefits include using a combination a sources and analysis techniques to construct a correlation database to assist in anomaly diagnosis and reporting for one or more monitored computer systems. Using coexistence analysis, semantic analysis, and/or knowledge-based analysis with documentation and historical data can result in improved accuracy in populating the correlation database to support anomaly detection.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

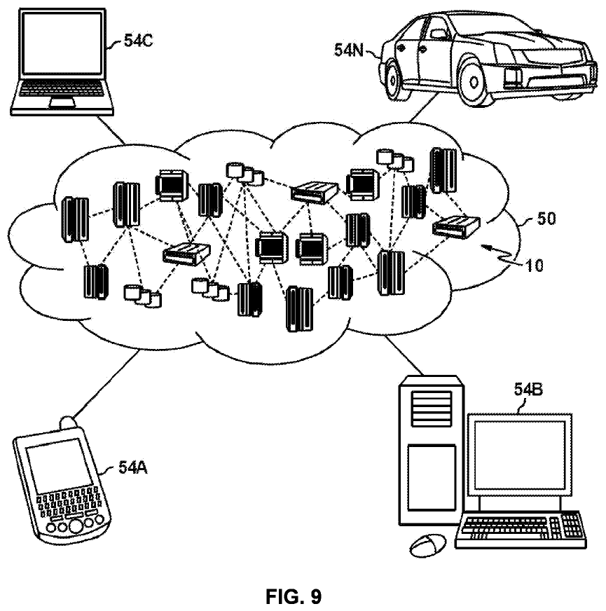

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

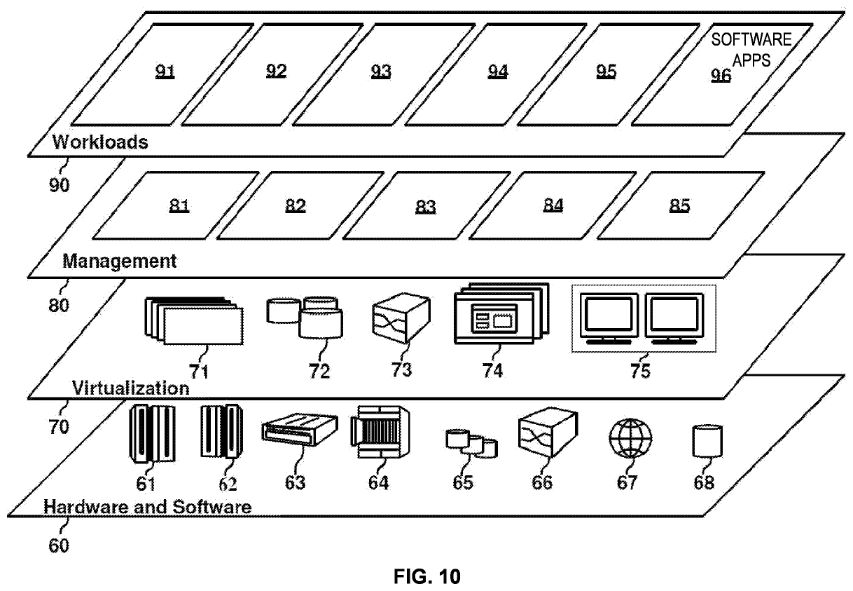

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and software applications 96 (e.g., software applications 230 of FIG. 2), etc. Also, software applications can function with and/or be integrated with Resource provisioning 81.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
identifying a plurality of metrics and log identifiers that describe similar information as a plurality of documentation-based correlation data;
identifying one or more metric pair correlations;
identifying, by temporal correlation, one or more log frequency correlations;
identifying a plurality of correlated metric-log pairs; and
populating a correlation database with the documentation-based correlation data, the one or more metric pair correlations, the one or more log frequency correlations, and the correlated metric-log pairs to support anomaly detection in one or more monitored computer systems.

2. The computer-implemented method of claim 1, further comprising:
performing a coexistence analysis to identify each of the metrics and related explanation documentation.

3. The computer-implemented method of claim 2, wherein one or more metric correlations are defined based on user input.

4. The computer-implemented method of claim 2, wherein the similar information is identified based on a semantic analysis of the related explanation documentation using natural language processing.

5. The computer-implemented method of claim 1, further comprising:
performing a coexistence analysis to identify one or more log identifiers from one or more history logs and related explanation documentation.

6. The computer-implemented method of claim 5, wherein one or more log identifier correlations are defined based on user input.

7. The computer-implemented method of claim 5, wherein the similar information is identified based on a semantic analysis of the related explanation documentation using natural language processing to identify one or more correlated log identifier pairs.

8. The computer-implemented method of claim 1, further comprising:
analyzing a plurality of metric pair combinations to determine a correlation coefficient between pairs of the metric series, wherein the one or more metric pair correlations are identified based on comparing the correlation coefficient between pairs of the metric series to a metric correlation threshold.

9. The computer-implemented method of claim 1, wherein the temporal correlation comprises determining a correlation coefficient between pairs of log frequency series and identifying the one or more log frequency correlations based on comparing the correlation coefficient between pairs of log frequency series to a log frequency correlation threshold.

10. The computer-implemented method of claim 1, further comprising:
analyzing a plurality of metric series temporally aligned with a plurality of log frequency series to determine a correlation coefficient between pairs of metric series and the log frequency series, wherein the correlated metric-log pairs are identified based on comparing the correlation coefficient between pairs of metric series and the log frequency series to a metric-log pair correlation threshold.

11. A system comprising:
a memory having computer readable instructions; and
one or more processors for executing the computer readable instructions, the computer readable instructions controlling the one or more processors to perform operations comprising:
identifying a plurality of metrics and log identifiers that describe similar information as a plurality of documentation-based correlation data;
identifying one or more metric pair correlations;
identifying, by temporal correlation, one or more log frequency correlations;
identifying a plurality of correlated metric-log pairs; and
populating a correlation database with the documentation-based correlation data, the one or more metric pair correlations, the one or more log frequency correlations, and the correlated metric-log pairs to support anomaly detection in one or more monitored computer systems.

12. The system of claim 11, wherein the computer readable instructions control the one or more processors to perform operations comprising:
performing a coexistence analysis to identify each of the metrics and related explanation documentation, wherein the similar information is identified based on a semantic analysis of the related explanation documentation using natural language processing.

13. The system of claim 11, wherein the computer readable instructions control the one or more processors to perform operations comprising:
performing a coexistence analysis to identify one or more log identifiers from one or more history logs and related explanation documentation, wherein the similar information is identified based on a semantic analysis of the related explanation documentation using natural language processing to identify one or more correlated log identifier pairs.

14. The system of claim 11, wherein the computer readable instructions control the one or more processors to perform operations comprising:
analyzing a plurality of metric pair combinations to determine a correlation coefficient between pairs of the metric series, wherein the one or more metric pair correlations are identified based on comparing the correlation coefficient between pairs of the metric series to a metric correlation threshold.

15. The system of claim 11, wherein the temporal correlation comprises determining a correlation coefficient between pairs of log frequency series and identifying the one or more log frequency correlations based on comparing the correlation coefficient between pairs of log frequency series to a log frequency correlation threshold.

16. The system of claim 11, wherein the computer readable instructions control the one or more processors to perform operations comprising:
analyzing a plurality of metric series temporally aligned with a plurality of log frequency series to determine a correlation coefficient between pairs of metric series and the log frequency series, wherein the correlated metric-log pairs are identified based on comparing the correlation coefficient between pairs of metric series and the log frequency series to a metric-log pair correlation threshold.

17. A computer program product comprising a computer readable storage medium having program instructions embodied therewith, the program instructions executable by a processor to cause the processor to perform operations comprising:
identifying a plurality of metrics and log identifiers that describe similar information as a plurality of documentation-based correlation data;
identifying one or more metric pair correlations;
identifying, by temporal correlation, one or more log frequency correlations;
identifying a plurality of correlated metric-log pairs; and
populating a correlation database with the documentation-based correlation data, the one or more metric pair correlations, the one or more log frequency correlations, and the correlated metric-log pairs to support anomaly detection in one or more monitored computer systems.

18. The computer program product of claim 17, wherein the program instructions cause the processor to perform operations comprising:
performing a coexistence analysis to identify each of the metrics and related explanation documentation, wherein the similar information is identified based on a semantic analysis of the related explanation documentation using natural language processing; and
performing a coexistence analysis to identify one or more log identifiers from one or more history logs and related explanation documentation, wherein the similar information is identified based on a semantic analysis of the related explanation documentation using natural language processing to identify one or more correlated log identifier pairs.

19. The computer program product of claim 17, wherein the program instructions cause the processor to perform operations comprising:
analyzing a plurality of metric pair combinations to determine a metric correlation coefficient between pairs of the metric series, wherein the one or more metric pair correlations are identified based on comparing the metric correlation coefficient between pairs of the metric series to a metric correlation threshold, and wherein the temporal correlation comprises determining a log correlation coefficient between pairs of log frequency series and identifying the one or more log frequency correlations based on comparing the log correlation coefficient between pairs of log frequency series to a log frequency correlation threshold.

20. The computer program product of claim 17, wherein the program instructions cause the processor to perform operations comprising:
analyzing a plurality of metric series temporally aligned with a plurality of log frequency series to determine a correlation coefficient between pairs of metric series and the log frequency series, wherein the correlated metric-log pairs are identified based on comparing the correlation coefficient between pairs of metric series and the log frequency series to a metric-log pair correlation threshold.
